(19) United States
(12) Patent Application Publication
(10) Pub. No.: US 2019/0127494 A1
(43) Pub. Date: May 2, 2019

(54) Method for Obtaining at Least One or More Beta-Glucan Compounds or a Solids Suspension Containing Beta Glucan from Yeast Cells

(71) Applicant: GEA Mechanical Equipment GmbH, Oelde (DE)

(72) Inventors: Steffen HRUSCHKA, Oelde (DE); Joachim WEINEKOETTER, Oelde (DE)

(73) Assignee: GEA Mechanical Equipment GmbH, Oelde (DE)

(21) Appl. No.: 16/094,286

(22) PCT Filed: Apr. 10, 2017
(86) PCT No.: PCT/EP2017/058534

§ 371 Date: Oct. 17, 2018

(30) Foreign Application Priority Data
Apr. 18, 2016 (DE) 10 2016 107 140.4

(51) Int. Cl. C08B 37/00; B01D 21/26

(52) U.S. Cl. CPC C08B 37/0024; B01D 21/262

(57) ABSTRACT

The invention relates to a method for obtaining beta glucan from yeast cells, at least comprising the following steps: A. enriching yeast cells (10); B. forming a yeast suspension comprising at least constituents of the yeast cells enriched in accordance with step A); C. treating the yeast suspension in a nanocavitator (70, 70′, 70′″, 70′″), and D. separating (80) beta glucan as solid or a solid suspension containing beta glucan from the yeast suspension.

The present invention relates to a method for recovering at least one or more beta-glucan compounds or a beta-glucan-containing solids suspension from yeast cells.

Beta-glucans can be put to good use in many respects. Therefore, the industrial recovery thereof is gaining the increasing attention of various industrial sectors, for example the feed industry and pharmaceutical industry.

A possible recovery from oat bran has been described by Michael Urs Beer in his ETH Zürich dissertation from 1994, titled “Gewinnung einer β-Glucan-reichen Haferkleiefraktion and deren Einfluss auf den Cholesterinspiegel in Blut des Menschen” [Recovery of a β-glucan-rich oat bran fraction and the influence thereof on the level of cholesterol in human blood].

WO 2008/138559 A1 discloses a method for isolating glucan from yeast with the aid of ultrasound. This involves the use of superheated steam in order to initially digest yeast cells relatively strongly. The yeast cells are preserved during the application of ultrasound waves. The vacuole contents are extracted through the cell wall. In the course of this, cavitation effects may arise, but they lead to the obstruction of mass transfer through the cell wall due to gas formation at the cell wall, and this is why a temperature should be kept as low as possible to lower the energy input in order to minimize cavitation effects. The occurrence of cavitation effects is thus an undesired effect which prevents an extraction through the cell wall.

DE 696 30 455 T2 likewise discloses an ultrasound treatment for the extraction of yeast cell ingredients from the yeast cell.

DE 198 35 767 A1 describes a method in which yeast cells are initially mechanically disrupted by shearing, followed by a washing and freeze-drying step and lastly an enzymatic digestion step to recover beta-glucans as a solids fraction.

It is now an object of the present invention to provide a recovery method which takes a different path in the recovery of beta-glucans, especially with higher yields and with chemical savings.

The present invention achieves this object by a method having the features of claim 1.

A method according to the invention for recovering one or more beta-glucan compounds from yeast cells is characterized by the following steps:

A. enrichment of yeast cells, especially by propagation in a sugar solution;
B. formation of a yeast suspension comprising at least constituents of the yeast cells enriched according to step A;
C. treatment of the yeast suspension in a nanocavitator and
D. removal of the beta-glucan compound or the beta-glucan compounds as solid or of a beta-glucan-containing solids suspension from the yeast suspension.

Using the method according to the invention, it is thus possible to recover at least one beta-glucan compound or else a mixture of a plurality of different beta-glucan compounds as well.

Alternatively, what can also be made possible is a beta-glucan-containing solids suspension as a consequence of removing extract, for example a yeast extract or a wash extract. The beta-glucan content of the solids suspension will be greater the higher the extract fraction in the removed extract.

Consequently, the nanocavitator does not necessarily need to be used at the end of the recovery method, but can instead be used at various steps of the recovery method. It is also possible to use a plurality of nanocavitators in the recovery method, or one nanocavitator for processing beta-glucan-containing yeast suspensions which arise in various steps of the recovery method.

The yeast suspension in step B is preferably to be understood as a suspension and/or dispersion containing solids, in particular containing yeast constituents which are present in a native state, denatured state or at least partially disrupted state.

For yeast cell cultivation, sugar water can preferably be used the enrichment of yeast cells or yeast-fungus cells.

It is then possible to form a yeast suspension which comprises at least constituents or whole yeast cells which were obtained previously. The yeast cells can be already crumbled or autolysed. The yeast suspension can be provided in different ways. For example, the so-called fermentation broth can be directly concerned. However, the yeast suspension can preferably be formed by removal of the sugar solution and, after the yeast cells have been autolysed, by addition of an aqueous alkali.

In the context of the present invention, one possibility as yeast suspension comprising at least constituents of the yeast cells obtained according to step A is therefore a plurality of yeast-containing suspensions which can arise over the course of processing the yeast cells. Particularly preferably, the yeast suspension can be an alkaline aqueous yeast suspension which has already been cleared of a multiplicity of accompanying substances by previous autolysis and washing and in which dead or autolysed yeast cells are present in a greatly predominant proportion, which cells may in some cases possibly also be already broken up into their constituents, with the result that only cell wall fragments are present.

Thereafter, the yeast suspension is treated with a nanocavitator. In contrast to cell shearing, what takes place in the nanocavitator is a partial vaporization of the solvent, preferably of water, with the result that soluble constituents of the yeast cell that are to be removed, especially of the yeast cell wall, dissolve distinctly better in the solvent. Moreover, the inner structure of the yeast cells changes, with the result that ingredients and accompanying substances of the yeast cell can be delivered more easily to the solvent.

Further advantageous embodiments of the invention are subject matter of the dependent claims.

It is advantageous when the yeast suspension to be treated in step C is an alkaline yeast suspension having a pH which is equal to or greater than pH=11. The alkaline yeast suspension can be in particular an aqueous yeast suspension. The pH can preferably exhibit a pH of pH=12 or higher.

The recovery of the beta-glucan compound or the beta-glucan compounds as solid or of the beta-glucan-containing solids suspension from the yeast suspension can advantageously be carried out by filtration using a filtration device and/or separation in the centrifugal field of a separator.

The solids suspension in the context of the present invention is preferably an aqueous solids suspension. In the context of the present invention, moist solids are also to be understood as solids suspension.

The yeast suspension is preferably formed as an aqueous suspension.

It is advantageous when the recovery of the beta-glucan compound or the beta-glucan compounds as solid or of a beta-glucan-containing solids suspension from the yeast suspension is carried out by filtration using a filtration device and/or separation in the centrifugal field of a separator.

The formation of the yeast suspension according to step B can advantageously encompass an autolysis of the yeast cells. Right after the autolysis has been carried out, it is then possible to use the nanocavitator.

However, it is even more advantageous when the formation of the yeast suspension according to step B encompasses, after the autolysis, a removal of a first liquid phase comprising the nutrient solution and the cell extract of the yeast cells to form a solid phase or a second solids-containing liquid phase. Since the first liquid phase comprises very many dissolved compounds, it is better to remove them first from the method in order to subsequently carry out a further extraction using a suitable solvent and, if necessary, under an adjusted pH too.

Particularly advantageously, the formation of the yeast suspension according to step B can therefore also encompass a washing of the solid phase and/or the second solids-containing liquid phase once or preferably multiple times in order to wash out further readily soluble contaminants.

The formation of the yeast suspension can, according to step B, encompass a suspending of the autolysed yeast cells, with the yeast suspension undergoing a treatment with the nanocavitator and/or with the treatment of the yeast suspension by the nanocavitator being carried out after the addition alkaline solution, especially an alkali.

The formation of the yeast suspension according to step B can then encompass a suspending and/or dispersing of the autolysed yeast cells, especially after the washing, in an aqueous alkali to form the aqueous solution. Said aqueous solution is alkaline and dissolves accompanying substances from yeast cell walls particularly well, with the result that a highly pure beta-glucan fraction can be recovered.

From the preceding wording, it is clear that the yeast suspension in step B can be simply the sugar solution itself with the yeast cells cultivated therein, but it is also possible for a solid or the solids-containing liquid phase to be provided with alkali with or without an optional wash procedure and to be then transferred into the nanocavitator.

In addition to the treatment of the yeast suspension in a nanocavitator, a treatment of the yeast suspension can advantageously be carried out in a homogenizer and/or in a mixing device. In the case of the latter devices, shearing of the yeast cells takes place in contrast to nanocavitation.

It is advantageous when the additional treatment of the yeast suspension in the homogenizer and/or in the mixing device is carried out immediately before or after the treatment of the yeast suspension with the nanocavitator. This prevents an excessively strong agglomeration of the yeast cell constituents.

During the treatment in the nanocavitator, the temperature of the yeast suspension can advantageously be between 20 and 90° C., preferably between 50 to 60° C.

The treatment in the nanocavitator can preferably be carried out multiple times.

Alternatively or additionally, the yeast suspension can advantageously be guided in a loop, with the result that it is conducted multiple times through the nanocavitator within one time interval.

To advantageously obtain a large yield of yeast cells, the enrichment of the yeast cells is carried out in a sugar solution without exclusion of oxygen.

The process parameters for the treatment with the nanocavitator, especially the duration of the treatment, the working pressure and/or the temperature of the yeast suspension, can be regulated and/or controlled on the basis of the particle size distribution of the yeast constituents in the yeast suspension and/or dynamic viscosity as a function of the shear rate.

The formation of a yeast suspension according to step B is not restricted to a specific method step; instead, the formation of an appropriate beta-glucan-containing or yeast cell wall-containing yeast suspension can occur in various steps in the recovery method. Advantageously, the yeast suspension formed according to step B can be present
a) after the enrichment of the yeast cells and before the autolysis
b) after the autolysis and before the separation of the yeast extract
c) during the washing and before the removal of the wash extract and/or
d) after the addition of alkali and be treated by the nanocavitator.

The invention will be more particularly elucidated below on the basis of the accompanying figures and on the basis of one embodiment, where:

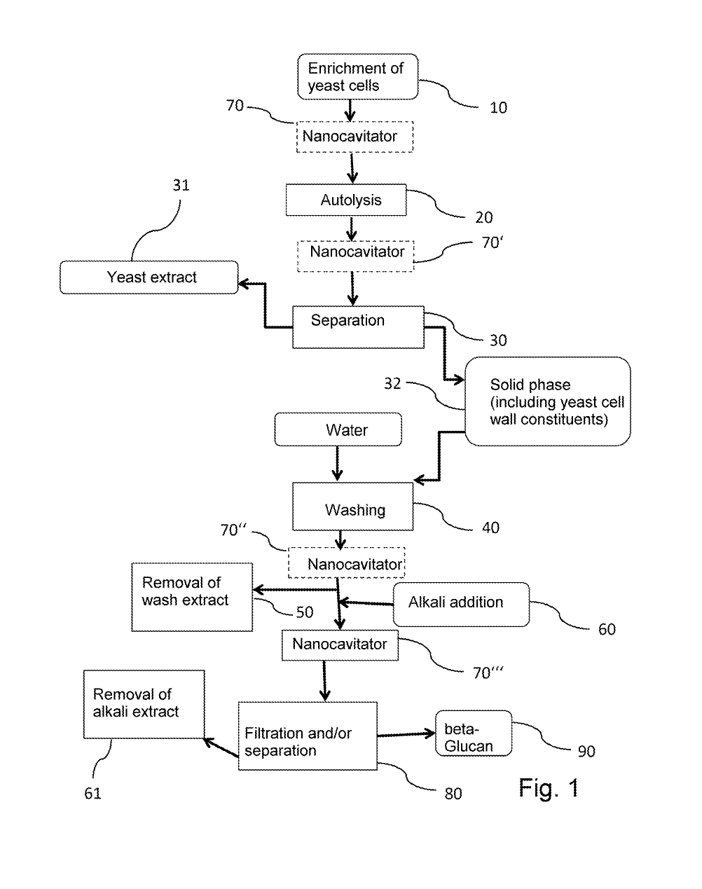

FIG. 1 shows a diagram of the sequence of a preparation method according to the invention;

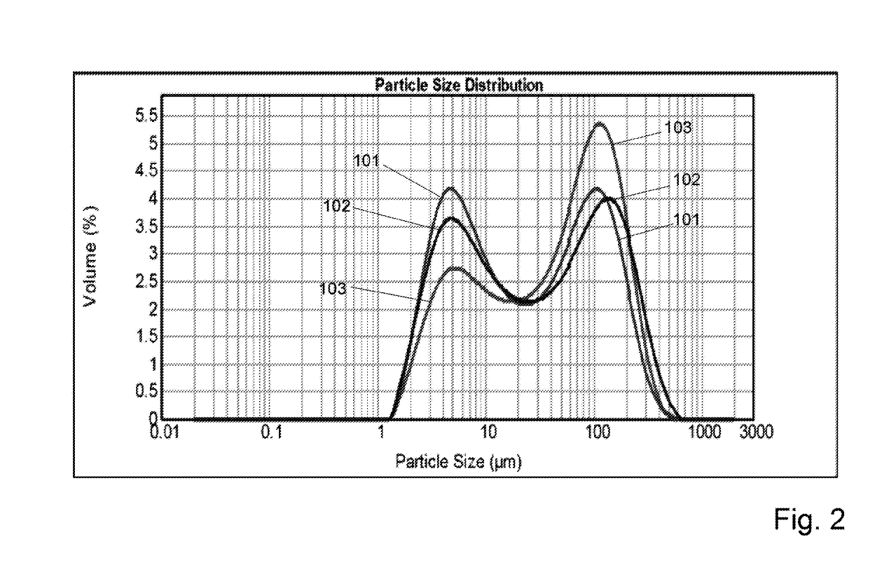

FIG. 2 shows a graph concerning the particle size distribution of alkaline yeast suspensions containing yeast cell constituents before, during and after nanocavitation; and

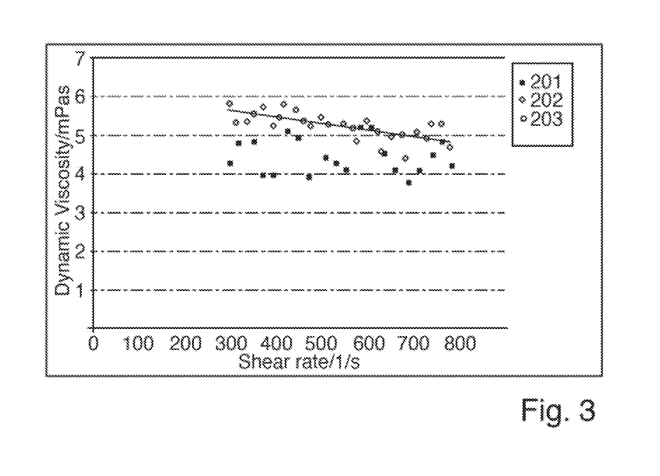

FIG. 3 shows a graph of the dynamic viscosity as a function of the shear rate in the alkaline yeast suspensions containing yeast cell constituents from FIG. 2.

In the prior art, treating yeast cells with ultrasound is known, which treatment makes it possible to carry out an extraction of cell contents through the cell wall. To this end, hot steam can be used as a supportive measure in order to increase the permeability of the cell wall and to thus facilitate conveyance through the cell wall. During the treatment with ultrasound, cavitation may occur, which, however, bathes the cell wall surface with gas and is therefore rather undesirable. At the same time, the extraction through the cell wall is done upon liquid contact with the cell wall. This means that the treatment with ultrasound supports mass transfer and the cavitation at the cell surface is obstructive thereto.

The treatment in a nanocavitator differs distinctly from the treatment with ultrasound. The suspension to be treated is pressed into the nanocavitator under high pressure by means of a pump. The specific flow geometry leads, within the nanocavitator, to regions in which the pressure of the liquid falls to the extent that the boiling point of the liquid is fallen short of and it vaporizes abruptly. The energy released here leads inter alia to damage to the cell walls of the yeast situated in the suspension.

After the cell walls of the yeast cells have been damaged, the removal of glucan from the yeast suspension can subsequently be done in the centrifugal field and/or in a pressure filter and/or a press. Thus, the cavitation effect is decoupled from the extraction, in contrast to the prior-art treatment with ultrasound, where both take place simultaneously and the cavitation impedes transport. Owing to damage to the cell wall, the extraction can be done substantially more effectively and, owing to the spatial decoupling of both process steps, it is possible to simplify a device for the realization of the method.

FIG. 1 shows, by way of example, a method sequence for a method according to the invention for recovering one or more beta-glucan compounds from yeast cells.

The glucan class of substances are polysaccharides consisting of glucose monomer units which are linked in an alternating manner via beta-1,6-, -1,3- and -1,2-glycosidic bonds. It is known that they form the support frame of yeast cell walls. Beta-glucan has positive properties on the immune system and is therefore used as a possible substitute for or as a supplement to antibiotics. Alternatively, it can also be used as a food supplement in order to lower the mortality rate of organisms, especially of aquatic organisms, for example shellfishes, fishes and the like. Beta-glucans can therefore be used as animal feed, too, for cattle, pigs and poultry.

Cell walls of yeasts substantially consist of beta-glucans, mannan sugar polymers, proteins, lipids and low fractions of chitin. In the context of the present invention, dissolving out these residual compounds as completely as possible is applicable when recovering beta-glucans.

To recover beta-glucans from yeast fungi in accordance with the method according to the invention, an enrichment of yeast fungi of one or more yeast cultures is carried out in a first step 10. This is carried out in a yeast enrichment. Preferably, yeast enrichment can be carried out not as alcoholic fermentation, but with action of oxygen in a sugar solution, this leading to an enrichment of the yeast fungi. In comparison, the use of a yeast-fungus cultivation during an alcoholic fermentation is less high-yield and consequently less preferred. The nutrient solution containing the cultivated yeast cells is a formed yeast suspension according to step B.

Right after the cultivation, a treatment of the yeast cells by a nanocavitator 70 can optionally and advantageously be carried out. This leads to a disruption of a multiplicity of yeast cells.

After the yeast cells have been propagated in a cultivation tank, said yeast cells can be further processed by means of autolysis in an enzymatic, thermal or mechanical manner in a further method step 20. The autolysis is the enzymatic self-digestion of yeast cells, which, in the context of the present invention, can be supported mechanically and/or thermally. Moreover, it is further additionally possible to add enzymes which allow or support autolysis through killing or support of yeast-endogenous enzymes.

Said autolysis is usually associated with a large portion of the yeast cells dying off. The autolysed yeast suspension thus comprises solids in the form of living and dead yeast cells, and also of solid fragments, for example of the yeast cell wall, and of the yeast extract 31.

Said yeast suspension can likewise be a yeast suspension according to step B of the method according to the invention and it can optionally be treated with a nanocavitator 70′.

It is then possible in a further method step to carry out a separation or a removal 30 of the yeast cells and yeast cell constituents as solid phase 32 from the sugar or nutrient solution 31 and further soluble constituents of the cell, for example the cell extract, or in some cases also from living cells.

The separation is preferably carried out in a centrifugal field of a separator. Alternatively or additionally, a filtration can also be carried out. The separation 30 yields a protein-containing phase 31 and a solid phase 32 containing yeast-fungus cells, yeast-fungus cell fragments, dead yeast-fungus cells, yeast-fungus cell walls and living yeast-fungus cells having a density greater than water.

Subsequently, said solid phase 32 can, as part of a post-treatment, be subjected to a one-step or multistep wash 40 in order to possibly also recover further accompanying substances. In this connection, it is possible to use solvents, especially water, which are intended, firstly, to support the digestion of the cells and, secondly, to ensure microbiological stability. The yeast-endogenous proteases and hydrolases then hydrolyze the cell contents, the result being that proteins are cleaved into peptides and amino acids and that DNA and RNA are cleaved to form nucleotides. To achieve a higher nucleotide content, the yeast-endogenous enzymes can be supplemented by addition of nucleases. This may inter alia be desirable because the ribonucleotides guanylic acid and inosinic acid multiply the flavor-enhancing effect of the yeast extract.

In said wash, the yeast suspension composed of water and yeast constituents can optionally be treated with a nanocavitator 70″.

To recover said cell-accompanying substances afterwards, the wash extract 50 is removed from the cell shells and the cell fragments preferably with the aid of centrifuges and/or filters.

The cell shell phase remaining after the removal of the wash extract and the accompanying substances contains substantial amounts of beta-glucans, which can be recovered in purified form by a further disruption of the cells.

The cell shell phase is dispersed and/or suspended in an alkaline, preferably aqueous, solution 60. The pH of said added solution or of the alkali is preferably pH=11 or higher. The alkali can preferably be an at least 20% strength alkali, especially an at least 30% strength alkali, the percentages being based on percent by weight of hydroxide salt in water.

An optional treatment of the dispersed and/or suspended cell shell phase is then carried out with a nanocavitator 70′″. In the case of such a nanocavitator, the alkaline fluid containing the suspended or dispersed yeast cell constituents flows through a channel comprising flow disturbances, with the result that a pressure increase and relief takes place in a nanocavitator several times in succession within fractions of a second, in contrast to a shearing, as takes place in an intensive mixer for example.

On the basis of Bernoulli's flow principle, it is possible to generate partially high flow velocities with low pressures, down to negative pressures, in immediate succession to the low flow velocities with high pressures up to 80 bar.

In this case, the relief is of such a magnitude that, in the case of the negative pressure arising owing to the flow, the solvent constituent of the fluid, for example water, passes into the gaseous state before it condenses in the next moment. This leads to a change in the yeast cell shells.

An appropriate nanocavitator can be purchased as the “nano cavitation reactor”, for example, from Cavitation Technologies Inc. (CTI).

Surprisingly, it is possible to achieve therewith an even higher extraction rate than in the case of repeated washing or of a pressure increase, for example when using a homogenizer.

The dry-matter content of the solids barely changes; however, the composition of the interstitial liquid, i.e., the continuous phase, does change. The interstitial solution or interstitial liquid is the liquid which is present between the yeast cells. It represents the continuum in the suspension. This is only explainable as a result of the material exchange, based on the cell, between exterior and interior and thus accounts for the higher extraction rates found.

The rheological behavior of the suspension also changes. Owing to the repeated cavitation effect, it is possible to observe a decrease in viscosity.

In the treatment by a nanocavitator, it was possible to observe a decrease in viscosity in the suspension without it being possible to identify a change to the cells optically. This is apparent from the fact that the particle size distribution does not show a significant change as a result of the use, but that the viscosity does decrease at comparable shear rates.

The Herschel-Bulkley plastic/dilatant flow behavior is thus maintained, but with significantly lower viscosities. This is attributed to a change to the suspended cells, since the dry-matter content has not been changed.

To obtain a purified beta-glucan phase, the alkali is then separated from the suspended and/or dispersed solids after the treatment in the nanocavitator. This can be done by a filtration or a separation in the centrifugal field of a separator.

The aforementioned sequence of the method describes a preferred way of recovering beta-glucans. However, it is also possible to recover beta-glucan directly after the autolysis by addition of an alkali and with use of a nanocavitator. In this connection, the further preparatory steps serve for better purity of the starting material before the transfer thereof into the nanocavitator and the isolation of further valuable products.

It is, for example, also possible to use a nanocavitator directly before or preferably after the autocatalysis. In the treatment of a yeast-containing yeast suspension with the nanocavitator, it is particularly preferably recommended if the yeast suspension has an alkaline pH in order to bring contaminants into solution more efficiently. Contaminants are thus removed from the nonsoluble beta-glucans.

The starting material before the treatment with the nanocavitator can consequently be a yeast suspension, enzymatically autolysed yeast suspension or washed yeast suspension concentrate before and after a pH shift.

The treatment of the yeast suspension with the nanocavitator is preferably carried out at pressures of from 50 to 150 bar, preferably at 60-90 bar.

The temperature of the yeast suspension containing the yeast constituents during the treatment thereof in the nanocavitator is from 20° C. to 90° C., preferably 50-60° C.

The treatment of the yeast suspension containing the yeast constituents by the nanocavitator can be carried out in a one-off or multiple pass or can be guided in a loop.

The alkaline digestion of the cell to release interfering substances, and ultimately to increase the purity of the beta-glucan-containing solid recovered from the yeast cell wall, is distinctly improved after the nanocavitation. The required alkali therefor is reduced to approximately 20-33% of the alkali amount in the absence of use of a nanocavitator. The salt load of the beta-glucan thereby decreases, i.e., it has a higher purity. Furthermore, the viscosity decreases.

Thereafter, the alkali is removed by filtration and/or centrifugal separation 80. What remains is a highly pure beta-glucan 90.

In addition, it is possible, for beta-glucan recovery, to use a mixing device and/or a homogenizer before or after the treatment by the nanocavitator. Particularly the alkaline yeast suspension containing the yeast cell constituents, in particular containing the cell wall constituents, can be transferred into the mixing device and/or the homogenizer in order to achieve there an improved dissolve-out of constituents from the cell wall. What remain as a result are beta-glucans of high purity.

FIG. 2 shows a particle size distribution 101 with the “particle size” in μm in relation to the “volume” in % in the yeast suspension) of the yeast cell constituents of an alkaline yeast suspension before the treatment with the nanocavitator, a particle size distribution 102 during the treatment with the nanocavitator and a particle size distribution 103 after the treatment with the nanocavitator. What can be seen is an increasing clumping or an agglomeration of the suspended solids within a yeast cell unit. However, at the same time, there is no change in the overall size of the yeast cell unit. This can be explained by the fact that the cells were completely disrupted in the case of a clumping and the cell constituents reoriented to form larger units or agglomerates. This disruption makes it possible to transfer further soluble constituents into the alkali or the alkaline solvent.

FIG. 3 shows a graph of the shear rate in relation to the dynamic viscosity for the yeast suspensions of FIG. 2. Before the treatment by the nanocavitator, there is a good correlation between the shear rate and the dynamic viscosity. Each of the measurement points 201 is on the correlation lines shown. Said measurement points 201 relate to the alkaline yeast suspension containing the yeast cell constituents before the treatment thereof with the nanocavitator. The measurement points 202 relate to the alkaline yeast suspension containing the yeast cell constituents after an initial treatment with the nanocavitator. What can still be seen is a certain correlation of the measurement points along the correlation lines. The measurement points 203 relate to the alkaline yeast suspension containing the yeast cell constituents after a complete treatment with the nanocavitator. What can be seen is no correlation at all between the dynamic viscosity and the shear rate.

The correlation can be explained by the fact that a relevant yeast suspension and/or yeast dispersion is a fluid, the viscosity of which decreases with higher shear rate. After the nanocavitation, there is a distinctly higher scattering of the measurement points with change in the shear rate. This can be explained by the fact that fragments of the yeast cells or fragments of the yeast cell wall are formed, which fragments are distinctly more finely dispersed. A correlation between shear rate and dynamic viscosity can no longer be observed in this case, meaning that the yeast cells and also the yeast cell walls have been completely broken up by the treatment with the nanocavitator.

For this purpose, it is possible with each possible use of the nanocavitator 70, 70′, 70″, 70′″ to treat the yeast suspension multiple times by the nanocavitator.

The nanocavitator can be used at multiple points of the method. According to the invention, the nanocavitator is, however, used at least once after formation of the yeast suspension.

### LIST OF REFERENCE SIGNS

10 Enrichment of yeast cells
20 Autolysis
30 Separation
31 Yeast extract
32 Solid phase containing solid yeast cell constituents and yeast cells
40 Washing
50 Removal of wash extract
51 Wash extract
60 Alkali addition or reaction
61 Alkali extract
70, 70′, 70″, 70′″ Nanocavitator
80 Filtration and/or separation
90 beta-Glucan
101-103 Measurement curves
201-203 Measurement points

1. A method for recovering one or more beta-glucan compounds or a beta-glucan-containing solids suspension from yeast cells, characterized by the following steps:
A. enrichment of yeast cells, especially by propagation in a sugar solution (10);
B. formation of a yeast suspension comprising at least constituents of the yeast cells enriched according to step A);
C. treatment of the yeast suspension at least once in at least one nanocavitator (70, 70′, 70″ and/or 70′″) and
D. removal of the beta-glucan compound or the beta-glucan compounds (90) as solid or of a beta-glucan-containing solids suspension from the yeast suspension.

2. The method as claimed in claim 1, characterized in that the yeast suspension to be treated in step C is an alkaline yeast suspension having a pH which is equal to or greater than pH=11.

3. The method as claimed in claim 1, characterized in that the recovery of the beta-glucan compound or the beta-glucan compounds (90) as solid or of the beta-glucan-containing solids suspension from the yeast suspension is carried out by filtration using a filtration device and/or separation in the centrifugal field of a separator (30, 50 and/or 80).

4. The method as claimed in claim 1, characterized in that the formation of the yeast suspension according to step B encompasses an autolysis (20) of the yeast cells.

5. The method as claimed in claim 4, characterized in that the formation of the yeast suspension according to step B encompasses, after the autolysis (20), a removal (30) of a yeast extract (31) to form a solid phase (32) or a second solids-containing liquid phase, the solid phase or the second liquid phase comprising solid constituents of the yeast cells and being beta-glucan-containing.

6. The method as claimed in claim 5, characterized in that the formation of the yeast suspension according to step B encompasses a washing (40) of the solid phase and/or the second solids-containing liquid phase once or preferably multiple times.

7. The method as claimed in claim 1, characterized in that the formation of the yeast suspension according to step B encompasses a suspending of the autolysed yeast cells.

8. The method as claimed in claim 7, characterized in that the yeast suspension undergoes a treatment with the nanocavitator (70, 70′ and/or 70″) and/or in that the treatment of the yeast suspension by the nanocavitator (70′″) is carried out after the addition alkaline solution, especially an alkali (60).

9. The method as claimed in claim 1, characterized in that, in addition to the treatment of the yeast suspension in a nanocavitator (70, 70′, 70″ and/or 70′″), a treatment of the yeast suspension is carried out in a homogenizer and/or in a mixing device.

10. The method as claimed in claim 9, characterized in that the additional treatment of the yeast suspension in the homogenizer and/or in the mixing device is carried out immediately before or after the treatment of the yeast suspension with the nanocavitator (70, 70′, 70″ and/or 70′″).

11. The method as claimed in claim 1, characterized in that, during the treatment in the nanocavitator (70, 70′, 70″ and/or 70′″), the temperature of the yeast suspension is carried out between 20 and 90° C., preferably between 50 to 60° C.

12. The method as claimed in claim 1, characterized in that the treatment in the nanocavitator (70, 70′, 70″ and/or 70′″) is carried out multiple times.

13. The method as claimed in claim 1, characterized in that the treatment in the nanocavitator (70, 70′, 70″ and/or 70′″) is carried out at pressures of from 50 to 150 bar, preferably at 60-90 bar.

14. The method as claimed in claim 1, characterized in that the yeast suspension is guided in a loop, with the result that it is conducted multiple times through the nanocavitator (70, 70′, 70″ and/or 70′″) within one time interval.

15. The method as claimed in claim 1, characterized in that the enrichment of the yeast cells (10) is carried out in a sugar solution without exclusion of oxygen.

16. The method as claimed in claim 1, characterized in that at least one process parameter for the treatment with the nanocavitator (70, 70′, 70″ and/or 70′″), especially the duration of the treatment, the working pressure and/or the temperature of the yeast suspension, is controlled and/or regulated on the basis of the particle size distribution of the yeast constituents in the yeast suspension and/or dynamic viscosity as a function of the shear rate.

17. The method as claimed in claim 1, characterized in that the yeast suspension formed according to step B is present
a) after the enrichment of the yeast cells (10) and before the autolysis (20)
b) after the autolysis (20) and before the separation of the yeast extract (31)
c) during the washing (40) and before the removal (50) of the wash extract (51) and/or
d) during the alkali reaction (60) and before the removal (80) of the alkali extract (81)
and is treated according to step C by the nanocavitator (70, 70′, 70″ and/or 70′″).
